(19) United States
(12) Patent Application Publication
(10) Pub. No.: US 2012/0173459 A1
(43) Pub. Date: Jul. 5, 2012

(54) NETWORK SYSTEM

(75) Inventors: Jinseong Hwang, Seoul (KR); Junyoung Lim, Seoul (KR); Munseok Seo, Seoul (KR); Jaehwa Jang, Seoul (KR)

(73) Assignee: LG ELECTRICS INC, SEOUL (KR)

(21) Appl. No.: 13/392,701

(22) PCT Filed: Aug. 27, 2010
(86) PCT No.: PCT/KR10/05792

§ 371 Date: Feb. 27, 2012

(30) Foreign Application Priority Data
Aug. 28, 2009 (KR) 10-2009-0080627
Aug. 28, 2009 (KR) 10-2009-0080630
Aug. 28, 2009 (KR) 10-20090080632
Jun. 26, 2010 (KR) 10-20090060901

(51) Int. Cl. G06Q 30/00

(52) U.S. Cl. 705/412

(57) ABSTRACT

A network system is provided. The network system includes: a plurality of components for transmitting or receiving information. At least one component among the plurality of components recognizes at least energy-related information and performs an energy-related response. When a first component in the plurality of components recognizes a course related to an operation of a second component, the first component recognizes a predicted energy usage charge on the basis of a predicted power consumption amount of the second component corresponding to the inputted course.

### TECHNICAL FIELD

The present disclosure relates to a network system.

### BACKGROUND ART

A provider simply provides energy source such as electricity, water, and gas, and a consumer simply uses the provided energy source. Therefore, effective management of the energy source may be hardly achieved in terms of energy production and distribution or energy use.

That is, energy is distributed from an energy provider to a plurality of consumers, that is, a radial structure radiating from the center to the periphery, and is based on a one-way provider not consumers.

Since limited price information on electricity is provided through a power exchange not in real time, and also its price system is actually a fixed price system, an inducement such as an incentive to consumers through price change is unavailable.

In order to resolve the above issue, there have been sustained efforts to realize horizontal, collaborative, and distributed networks until now, which may effectively manage energy and allow interactions between consumers and providers.

### DISCLOSURE OF THE INVENTION

### Technical Problem

Embodiments provide a network system for effectively managing an energy source.

Embodiments also provide a network system, through which a user may easily confirm predicted and/or actual energy usage charge according to operations of components.

### Technical Solution

In one embodiment, a network system includes: a plurality of components for transmitting or receiving information, wherein at least one component among the plurality of components recognizes at least energy-related information and performs an energy-related response; and when a first component in the plurality of components recognizes a course related to an operation of a second component, the first component recognizes a predicted energy usage charge on the basis of a predicted power consumption amount of the second component corresponding to the inputted course.

The details of one or more embodiments are set forth in the accompanying drawings and the description below. Other features will be apparent from the description and drawings, and from the claims.

### Advantageous Effects

According to the present invention, since components constituting a network system may transmit and/or receive at least energy information, effective management of an energy source is possible.

Additionally, since appliances may display a predicted power consumption amount and/or a predicted energy usage charge, a user may easily confirm energy related information. Thus, the user may effectively use the appliances in order to save energy or energy charge.

Furthermore, if correction is required because there is a difference between a predicted power consumption amount stored in a memory unit and an actual power consumption, the predicted power consumption amount stored in the memory unit is changed into the actual power consumption. Therefore, a more accurate predicted power consumption amount may be displayed.

### BRIEF DESCRIPTION OF THE DRAWINGS

FIG. 1 is a schematic view of a network system according to the present invention.

FIG. 2 is a schematic block diagram of a network system according to the present invention.

FIG. 3 is a block diagram illustrating an information delivery process on a network system according to the present invention.

FIG. 4 is a graph illustrating a form of an energy charge in a network system according to the present invention.

FIG. 5 is a schematic block diagram illustrating a first communication form of a network system according to the present invention.

FIG. 6 is a schematic block diagram illustrating a first communication form of a network system according to the present invention.

FIG. 7 is a schematic block diagram illustrating a first communication form of a network system according to the present invention.

FIG. 8 is a schematic view illustrating an HAN of a network system according to the present invention.

FIG. 9 is a perspective view illustrating a washing machine, which is an example of the first embodiment of an energy consumption component constituting a HAN of the present invention.

FIG. 10 is block diagram of the washing machine of FIG. 9.

FIG. 11 is a view illustrating information stored in a memory unit of a washing machine.

FIG. 12 is a flowchart illustrating a control method of a network system according to a first embodiment of the present invention.

FIG. 13 is a flowchart illustrating a control method of a network system according to a second embodiment of the present invention.

FIG. 14 is a view illustrating information displayed on a display unit according to a second embodiment of the present invention.

FIG. 15 is a block diagram of a washing machine according to a third embodiment of the present invention.

FIG. 16 is a flowchart illustrating a control method of a network system according to a third embodiment of the present invention.

FIG. 17 is a flowchart illustrating a control method of a network system according to a third embodiment of the present invention.

FIG. 18 is a view illustrating a display unit of a washing machine according to a fourth embodiment of the present invention.

FIG. 19 is a block diagram of an air conditioner constituting an HAN according to a sixth embodiment of the present invention.

FIG. 20 is a perspective view of the refrigerator of FIG. 19.

FIG. 21 is a block diagram illustrating a configuration of the refrigerator of FIG. 19.

FIG. 22 is a flowchart illustrating a control method of a network system according to a first embodiment of the present invention.

FIG. 23 is a view illustrating information displayed on a display unit of a refrigerator according to a fifth embodiment of the present invention.

FIG. 24 is a block diagram of an air conditioner constituting an HAN according to a sixth embodiment of the present invention.

FIG. 25 is a view illustrating information displayed on a display unit according to a second embodiment of the present invention.

FIG. 26 is a view illustrating information displayed on a display unit of a refrigerator according to a fifth embodiment of the present invention.

FIG. 27 is a view illustrating information displayed on a display unit of a refrigerator according to a fifth embodiment of the present invention.

### BEST MODE FOR CARRYING OUT THE INVENTION

Reference will now be made in detail to the embodiments of the present disclosure, examples of which are illustrated in the accompanying drawings.

Hereinafter, embodiments of the present invention will be described with reference to the accompanying drawings. Embodiments mentioned in this specification are independent, and at least two of them may be combined to drive another embodiment, which also belongs to the scope of the present invention.

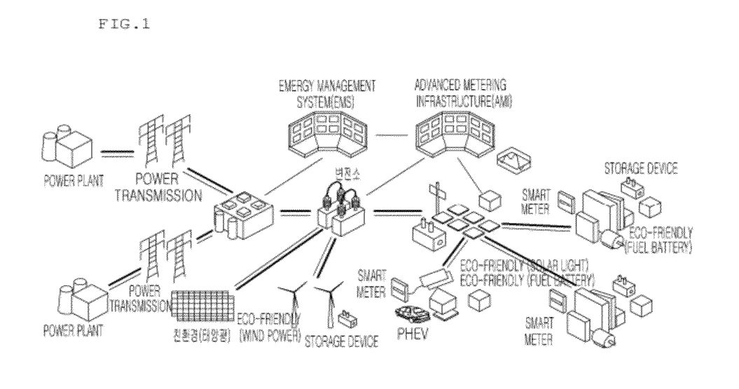

FIG. 1 is a schematic view of a network system according to the present invention.

The network system is a system for managing an energy source such as electricity, water, and gas. The energy source may mean one whose generation amount or usage amount can be metered.

Accordingly, an energy source, not mentioned in the above, may be a management target of the system. Hereinafter, electricity may be described as one example of an energy source, and the contents of this specification may be identically applied to another energy source.

Referring to FIG. 1, the network system according to an embodiment includes a power plant for generating electricity. The power plant may include a power plant for generating electricity through thermal power generation or nuclear power generation and a power plant for generating electricity through eco-friendly energy such as water power, solar light, and wind power.

Moreover, the electricity generated in the power plant is transmitted to a power station, and then, is transmitted to a substation, so that it is distributed to consumers such as homes and offices.

Additionally, the electricity generated by eco-friendly energy is transmitted to a substation, so that it is distributed to each consumer. Moreover, the electricity transmitted from the substation is distributed to each office or home through an electricity storage device or directly.

A home using Home Area Network (HAN) may generate electricity by itself through a fuel cell mounted in a Plug in Hybrid Electric Vehicle (PHEV) or solar light, store and distribute it, or resell the remaining electricity to an outside (for example, an electric power company).

Furthermore, the network system may include a smart meter for measuring an electricity usage amount of a consumer (home or office) in real time and an Advanced Metering Infrastructure (AMI) for measuring electricity usage amounts of a plurality of consumers in real time. That is, the AMI may measure an electricity usage amount by receiving information measured by a plurality of smart meters.

In the specification, the above measurement includes measurement by a smart meter and AMI, and recognition by a smart meter and AMI by receiving generation amount or usage amount from another component.

Furthermore, the network system may further include an Energy Management System (EMS) for managing energy. The EMS may generate information on operations of at least one component in relation to energy (generation, distribution, use, and storage of energy). The EMS may generate at least a command related to an operation of a component.

In this specification, a function or solution performed by the EMS may be referred to as an energy management function or an energy management solution.

In the network system of the present invention, there may be at least one EMS as an additional configuration separated from another component, or the EMS may be included in at least one component as an energy management function or solution.

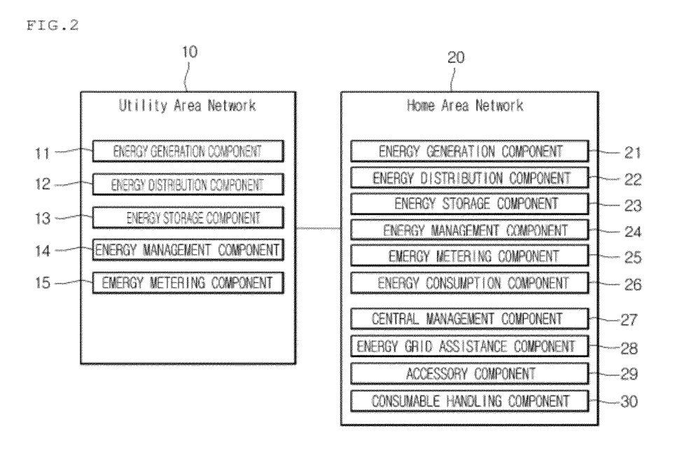

FIG. 2 is a schematic block diagram of a network system according to the present invention.

Referring to FIGS. 1 and 2, the network system of the present invention is configured using a plurality of components. For example, components of the network system include a power plant, a substation, a power station, an EMS, an appliance, a smart meter, a capacitor, a web server, an AMI, and a home server.

Additionally, according to the present invention, each component may be configured by a plurality of detailed components. As one example, if one component is an appliance, a micom, a heater, a display, and a motor, which constitute the appliance, may be detailed components.

That is, anything for performing a specific function may be a component in the present invention, and these components constitutes the network system of the present invention. Moreover, two components may communicate with each other through a communication means.

Moreover, one network may be one component, or may be configured using a plurality of components.

In this specification, a network system, in which communication information relates to an energy source, may be called an energy grid.

A network system according to an embodiment may include a Utility Area Network (UAN) 10 and an HAN 20. The UAN 10 and the HAN 20 may provide wire or wireless communication through a communication means.

In the specification, a home matches a dictionary's definition, and also a group including specific components such as buildings and companies. Moreover, a utility means a group including specific components outside a home.

The UAN 10 may include at least one of an energy generation component 11 for generating energy, an energy distribution component 12 for distributing and/or delivering energy, an energy storage component 13 for storing energy, an energy management component 14 for managing energy, and an energy metering component 15 for metering energy related information. That is, the UAN 10 may include at least two kinds of components.

When at least one component constituting the UAN 10 consumes energy, a component that consumes energy may be an energy consumption component. That is, the energy consumption component may be separately configured or may be included in another component.

The energy generation component 11 may be a power plant, for example. The energy distribution component 12 distributes or delivers an energy generated from the energy generation component 11 or an energy stored in the energy storage component 13 to an energy consumption component. The energy distribution component 12 may be a power transmitter, a substation, or a power plant, for example.

The energy storage component 13 may be a capacitor, and the energy management component 14 may generate information for driving at least one of the energy generation component 11, the energy distribution component 12, the energy storage component 13, and the energy consumption component 26, in relation to energy. As one example, the energy management component 14 may generate at least a command related to an operation of a specific component.

The energy management component 14 may be an EMS. The energy metering component 15 may measure information on generation, distribution, consumption, and storage of energy, and may be an AMI, for example. The energy management component 14 may be separately configured or may be included in another component.

The UAN 10 may communicate with the HAN 20 through a terminal component (not shown). The terminal component may be a gateway, for example. This terminal component may be included in at least one of the UAN 10 and HAN 20.

Moreover, the HAN 20 includes at least one of an energy generation component 21 for generating energy, an energy distribution component 22 for distributing energy, and energy storage component 23 for storing energy, an energy management component 24 for managing energy, an energy metering component 25 for metering energy related information, an energy consumption component 26 for consuming energy, a central management component 27 for controlling a plurality of components, an energy grid assistance component 28, an accessory component 29, and a consumable handling component 30.

The energy generation component 21 may be a home use generator, the energy storage component 23 may be a capacitor, and an energy management component 24 may be an EMS.

The energy metering component 25 may measure information on generation, distribution, consumption, and storage of energy, and may be a smart meter, for example.

The energy consumption component 26 may include an appliance (which may be a refrigerator, a washing machine, an air conditioner, a cooking device, a cleaner, a drier, a dish washer, a dehumidifier, a display device, a lighting device, and so on, but is not limited thereto), or may include a heater, a motor, a display, and a control unit, which constitute an appliance. It is informed in this embodiment that there is no type limitation in the energy consumption component 26.

The energy management component 24 may be a separate component, or may be included in another component as an energy management function. The energy management component may communicate with at least one component to transmit/receive information.

The energy generation component 21, the energy distribution component 22, and the energy storage component 23 may be separate components, or may constitute a single component. As one example, the energy generation component 21 may include the energy distribution component 22, and the energy storage component 23.

The central management unit 27 may be a home server for controlling a plurality of appliances, for example.

The energy grid assistance component 28 is a component for performing an additional function for the energy grid and an original function. For example, the energy grid assistance component 28 may be a web service providing component (for example, a computer), a mobile device, or a television.

The accessory component 29 is an energy grid exclusive component for performing an additional function for an energy grid. For example, the accessory component 29 may be an energy grid exclusive weather receiving antenna.

The consumable handling component 30 is a component for storing, supplying, and delivering a consumable, and may confirm or recognize information on a consumable. The consumable may be an article or material, which is used or processed while the energy consumption component 26 operates. Also, the consumable handing component 30 may be handled by the energy management component 24 in an energy grid, for example.

For example, the consumable may be the laundry in a washing machine, the food in a cooking machine, a detergent or fabric softener for washing or softening the laundry in a washing machine, or a condiment for cooking a food.

The above mentioned energy generation components 11 and 21, energy distribution components 12 and 22, energy storage components 13 and 23, energy management components 14 and 24, energy metering components 15 and 25, energy consumption component 26, and central management component 27 may be separately provided, or at least two of them may constitute a single component.

For example, the energy management components 14 and 24, energy metering components 15 and 25, and central management component 27 may be provided as each single component, and thus, may serve as a smart meter, an EMS, and a home server, respectively. Or, the energy management components 14 and 24, energy metering components 15 and 25, and central management component 27 may mechanically constitute a single component.

Additionally, when one function is performed, it is sequentially performed in a plurality of components and/or communication means. For example, an energy management function may be performed sequentially in a separate energy management component, energy metering component, and energy consumption component.

Moreover, there may be a plurality of components having specific functions, which constitute a UAN and a HAN. For example, there may be a plurality of energy generation components or energy consumption components.

Additionally, the UAN 10 or the HAN 20 may communicate with each other through a communication means (for example, a first interface). At this point, a plurality of UANs 10 may communicate with a single HAN 20, and a single UAN 10 may communicate with a plurality of HANs 20.

As one example, the communication means may be a simple communication line or a power line communication means. The power line communication means may include a communication device (for example, a modem), which is connected to two components simultaneously. As another example, the communication means may be zigbee, wi-fi, and Bluetooth.

In this specification, there is no limitation in a wire communication method or a wireless communication method.

Two components constituting the UAN 10 may communicate with each other through a communication means.

Additionally, two components constituting the HAN 20 may communicate with each other through a communication means (for example, a second interface). As one example, the energy consumption component 26 may communicate with at least one of the energy management component 24, the energy metering component 25, the central management component 27, and the energy grid assistance component 28 through a communication means (for example, a second interface).

Moreover, a micom of each component (for example, the energy consumption component) may communicate with the communication means (for example, a second interface) through a communication means (for example, a third interface). For example, if the energy consumption component is an appliance, the appliance may receive information from the energy management component through a communication means (for example, a second interface), and may deliver the received information to its micom through a third interface.

Additionally, the energy consumption component 26 may communicate with the accessory component 29 through a communication means (for example, a fourth interface). Additionally, the energy consumption component 26 may communicate with the consumable handling component 30 through a communication means (for example, a fifth interface).

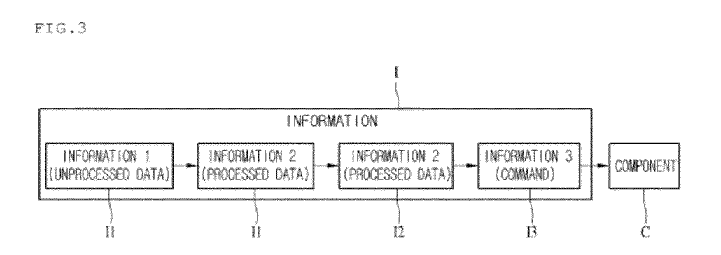

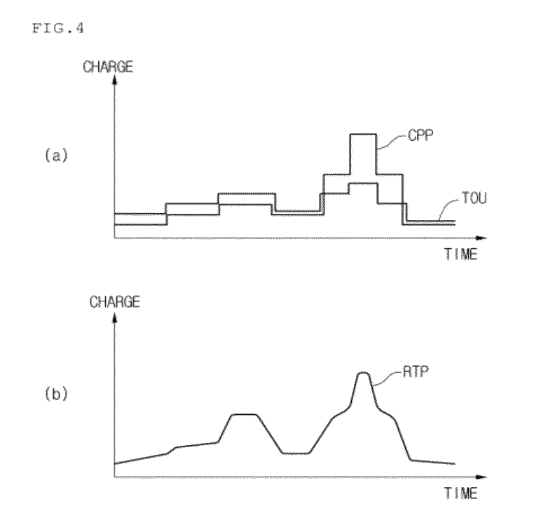

FIG. 3 is a block diagram illustrating an information delivery process on a network system according to the present invention. FIG. 4 is a graph illustrating an energy charge form. FIG. 4(a) is a graph illustrating Time Of Use (TOU) information and Critical Peak Pattern information. FIG. 4(b) is a graph illustrating Real Time Pattern (RTP) information.

Referring to FIG. 3, in the network system of the present invention, a specific component C may receive energy related information (hereinafter, referred to as “energy information) through a communication means. Moreover, the specific component C may further receive additional information (such as environmental information, program update information, time information, operation or state information on each component such as malfunction, and habit information on a user using an energy consumption component) in additional to the energy information through a communication means.

The environmental information may include carbon dioxide emission amount, carbon dioxide concentration in the air, temperature, humidity, precipitation, rainfall occurrence, insolation, and air volume.

In another aspect, the information may include internal information, that is, each component related information (operation or state information (such as malfunction) of each component, energy usage information of an energy consumption component, and habit information of a user using an energy consumption component) and external information (energy information, environmental information, program update information, and time information).

At this point, the above information may be received from another component. That is, the received information includes at least energy information.

The specific component may be one component constituting the UAN 10 or the HAN 20.

The energy information I may be one of electricity, water and gas information as mentioned above.

As one example, examples of the electricity related information may include time-based pricing, curtailment, grid emergency, grid reliability, energy generation amount, operation priority, and energy consumption amount. In this embodiment, a charge related to an energy source may be regarded as an energy charge.

That is, energy information includes charge information (energy charge: energy charge per unit time and total energy usage charge) and other than charge information (curtailment, grid emergency, grid reliability, energy generation amount, operation priority, and energy consumption amount).

This information may include scheduled information generated in advance based on previous information and real time information varying in real time. The scheduled information and the real time information may be divided based on information prediction after the current time (i.e., the future).

Moreover, the energy information I may be classified as TOU information, CPP information, or RTP information on the basis of a pattern change of data over time. Furthermore, the energy information I may vary over time.

Referring to FIG. 4(a), data are gradually changed over time according to the TOU information. According to the CPP information, data are gradually changed over time or in real time, and emphasis is indicated at the specific timing. That is, in the case of a CPP pattern, a general charge is cheaper than that of a TOU pattern but a charge at the specific timing is drastically more expensive than that of the TOU pattern.

Referring to FIG. 4(b), according to the RTP information, data are changed in real time over time.

Furthermore, the energy information I may be transmitted or received as a true or false signal such as Boolean, as actual price information, or as a plurality of levels. Hereinafter, electricity related information will be described with an example.

If the specific component C receives a true or false signal such as Boolean, one signal is recognized as an on-peak signal (i.e., information on energy consumption amount or curtailment of energy charge) and the other signal is recognized as an off-peak signal.

Unlike this, the specific component C may recognize at least one drive related energy information including an electricity charge, and may recognize one-peak and off-peak by comparing a recognized information value with a reference information value.

For example, if the specific component C recognizes leveled information or actual price information, it recognizes one-peak and off-peak by comparing a recognized information value with a reference information value.

At this point, the recognized information value may be one of electricity charge, power amount, a change rate of electricity charge, a change rate of power amount, an average value of electricity charge, and an average value of power amount. The reference information value may be at least one of a specific value, an average value, an average value of the minimum value and the maximum value of power information during a predetermined interval, and a reference change rate (for example, a slope of consumption power amount per unit time) of power information during a predetermined interval. At this point, the reference information value may be at least one. Additionally, the reference information value may vary for each component.

The reference information value may be set in real time or in advance. The reference information value may be set in a UAN or a HAN (which may be inputted through consumer direct input, an energy management component, or central management component).

If the specific component (for example, an energy consumption component) recognizes on-peak (for example, recognition time), it may output 0 (i.e., stop or maintain a stop status) or may reduce an output. The specific component may determine a driving type in advance before starting, and may change the driving type when recognizing on-peak after starting.

Moreover, when the specific component recognizes off-peak, it may restore or increase an output if necessary. That is, a specific component, which recognizes on-peak currently, recognizes off-peak, it may restore an output to a previous status or increase the output than before (i.e., which becomes in a different status than previous one).

At this point, when a specific component restores or increases an output after recognizing off-peak, it is obvious that an entire consumption power and/or total electricity usage charge are/is reduced during an entire driving time.

Or, if the specific component recognizes on-peak (for example, recognition time), it may maintain an output if satisfying an operational condition. At this point, the operational condition means a case that an information value for driving is less than a predetermined reference. The information value for driving may be information regarding electricity charge, power consumption amount, and energy related time or operation time. The predetermined reference may be a relative value or an absolute value.

As one example, the operational conditions include an on-peak interval being less than a predetermined time, an operation remaining time being less than a predetermined time, an energy charge being less than a predetermined charge when operating in an on-peak interval, an energy consumption amount being less than a predetermined amount when operating in an on-peak interval, and a ratio of an on-peak interval in an entire operation time being less than a predetermined ratio.

At this point, the specific component maintains an output if satisfying an operational condition like when an operation starting time of the specific component is in the on-peak interval during its stop status.

The predetermined reference may be set in real time or in advance. The predetermined reference may be set in a UAN or a HAN (which may be inputted through consumer direct input, an energy management component, or central management component).

Or, if the specific component recognizes on-peak (for example, recognition time), it may increase an output. However, even if an output is increased at the timing of recognizing on-peak, a total output amount of a specific component during an entire drive period may be reduced less than or maintained equal to that of when the specific component operates with a normal output.

Or, even if an output is increased at the timing of recognizing on-peak, a total output amount or a total electricity charge of a specific component during an entire drive period may be reduced less than that of when the specific component operates with a normal output.

That is, after an output of the specific component is increased, it may be reduced or becomes 0.

When the specific component recognizes off-peak (for example, recognition time), it may increase an output. For example, an operation reservation is set, a specific component may start to drive before a time set, or a component having the largest output among a plurality of components may start to drive first.

Additionally, it is possible to supercool a refrigerator by increasing an output than a typical output, or store warm water in a water tank for a washing machine and a dish washer by driving a heater before an operation reservation time of the heater. This is to reduce electricity charge by driving a component, which is supposed to operate in the upcoming on-peak, in off-peak in advance.

Or, when the specific component recognizes off-peak (for example, recognition time), it may store electricity (i.e., store energy generated in a UAN).

Or, when a specific component recognizes off-peak, generation amount may be reduced.

In the present invention, the specific component (for example, an energy consumption component) may maintain, reduce, or increase an output. Accordingly, a specific component may include a power changing component. Since the power may be defined by current and voltage, the power changing component may include a current adjustor and/or a voltage adjustor. The power changing component may operate in response to a command generated from an energy management component, for example.

Moreover, the curtailment information is information on a mode, in which a component stops or consumes less power for less energy charge. That is, the curtailment information is information on energy consumption amount or energy charge reduction.

The curtailment information may be transmitted or received as a true or false signal such as Boolean on a network system, for example. That is, a stop signal (e.g., a turn off signal) or a reduce signal (e.g., a lower power signal) may be transmitted/received.

If the specific component recognize curtailment information, as mentioned above, it may output 0 (stop or maintain a stop status: when recognizing a turn off signal) or reduce an output (when recognizing a lower power signal).

Or, if the specific component recognizes curtailment information (for example, recognition time), it may maintain an output if operational.

The grid emergency information may relates to power failure, and may be transmitted/received as a true or false signal such as Boolean, for example. The information on power failure relates to the reliability of a component using energy.

When the specific component recognizes grid information, it may be immediately shut down.

When the specific component receives the grid emergency information as scheduled information, it increases an output prior to an upcoming grid emergency timing, so that it may operate like in the above mentioned off-peak of the specific component. Moreover, the specific component may be shut down at the grid emergency timing.

The grid reliability information may relate to a large or small of supply electricity amount or electricity quality, may be transmitted/received as a true or false signal such as Boolean, and may be determined by a component through a frequency of AC power supplied to a component (for example, appliance).

That is, if a frequency, which is lower than a reference frequency of AC power supplied to a component, is recognized (identified), it is determined that electricity supply amount is small. Also, if an overfrequency, which is higher than the reference frequency of AC power, is recognized (identified), it is determined that electricity supply amount is large. That is, an underfrequency, which is lower than the reference frequency, corresponds to information on the reduction of energy consumption amount or energy charge.

When the specific component recognizes information on less electricity amount or poor electricity quality in grid reliability information, as mentioned above, the specific component may output 0 (stop or maintain a stop status), reduce an output, maintain an output, or increase an output if necessary.

Electricity generation amount excessive information may relate to information on a status, in which surplus electricity occurs because an electricity usage amount of a component that consumes an energy is less than a generation amount, and may be transmitted as a true or false signal as Boolean, for example.

When the specific component recognizes electricity generation amount excessive information (for example, recognizing a grid overfrequency or an over energy signal), it may increase an output. For example, if an operation reservation is set, a specific component starts to drive before set time, or a component having the largest output among a plurality of components may start to drive first. Additionally, it is possible to supercool a refrigerator by increasing an output than a typical output, or store warm water in a water tank for a washing machine and a dish washer by driving a heater before an operation reservation time of the heater

When the specific component recognizes information that energy consumption amount is less than reference amount, it may increase an output.

Moreover, in more detail, various kinds of information related to the energy may include unprocessed first information I1, second information I2 processed from the first information, and third information I3 for performing a function of the specific component. That is, the first information is raw data, the second information is refined data, and the third information is a command for performing a function of the specific component.

Moreover, energy related information is included in a signal and then is delivered. At this point, at least one of the first to third information may be delivered several times with only a signal changed and no content changed.

As one example, as shown in FIG. 3, one component receiving a signal including the first information I1 may convert only a signal, and then, may transmit a converted new signal including the first information I1 to another component.

Accordingly, signal conversion and information conversion are described as respectively different concepts in this embodiment. At this point, it is easily understood that a signal is also converted when the first information is converted into the second information.

However, the third information may be delivered several times with a content converted, or may be delivered several times with the same content maintained but only a signal converted.

In more detail, if the first information is unprocessed electricity charge information, the second information may be processed electricity charge information. As one example, the processed electricity charge information may be information on the electricity charge in a plurality of levels or analysis information on the electricity charge. The third information is a command generated based on the first information or the second information.

A specific component may generate, transmit, or receive at least one of the first to third information. The first to third information is not necessarily transmitted/received sequentially.

For example, only the third information may be sequentially or in parallel transmitted or received several times without the first and second information. Or, the first and third information is transmitted or received together, the second and third information is transmitted or received together, or the first and second information is transmitted or received together.

As one example, when a specific component receives first information, it may transmit the second information, the second and third information, or only the third information.

When a specific component receives the only the third information, it may generate and transmit new third information.

Moreover, in relation between two information, one information is a message and the other one is a response to the message. Accordingly, each component constituting the network system may transmit or receive a message and may respond to the received message if receiving a message. Accordingly, transmitting a message and responding to the message are relative concept in the case of a separate component.

The message may include data (first information or second information) and/or a command (third information).

The command (the third information) may include a data storing command, a data generating command, a data processing command (including generating additional data), a command for generating an additional commend, a command for delivering a received command, and an energy related operation command.

In the specification, responding to a received message means storing data, processing data (including generating additional data), generating a new command, transmitting a new generated command, simply delivering a received command (may generate a command for delivering the received command to another component), operating, transmitting stored information, and transmitting a confirmed message (acknowledge character or negative acknowledge character). That is, responding to a received message means performing a function that a specific component itself performs.

For example, if a message is first information, a component receiving the first information may generate second information by processing the first information, generate second information and new third information, or generate only third information, in response to the message.

In more detail, if the energy management component 24 receives first information (internal information and/or external information), it may generate second information and/or third information to transmit it to at least one component (for example, an energy consumption component) constituting the HAN. Moreover, the energy consumption component 26 may operate (for example, energy consumption) according to the received third information from the energy management component 24.

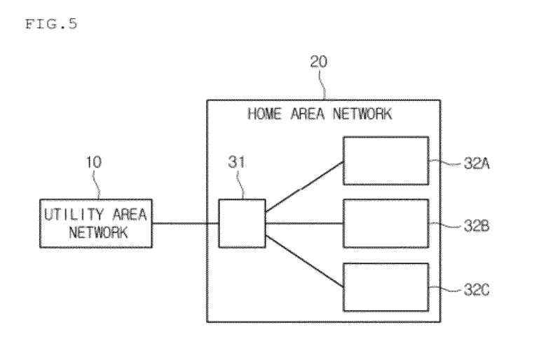

FIG. 5 is a schematic block diagram illustrating a first communication form of a network system according to the present invention.

Referring to FIG. 5, a first component 31 of the HAN 20 may directly communicate with the UAN 10. The first component 31 may communicate with a plurality of components 32A, 32B, and 32C, i.e., second to fourth components) of the HAN 10. At this point, it is informed that there is no limitation in the number of components in the HAN, which communicate with the first component 31.

That is, the first component 31 serves as a gateway in this embodiment. The first component 31 may be one of an energy management component, an energy metering component, a central management component, an energy grid assistance component, and an energy consumption component, for example.

In this present invention, a component serving as a gateway may allow components to communicate with each other through respectively different communication protocols, and may allow components to communicate with each other through the same communication protocol.

Each of the second to fourth components 32A, 32B, and 32C may be one of an energy generation component, an energy distribution component, an energy management component, an energy storage component, an energy metering component, a central management component, an energy grid assistance component, and an energy consumption component, for example.

The first component 31 may receive information from at least one component constituting the UAN 10 and the HAN 20, and then, may deliver or process the received information to transmit it to the second to fourth components 32A, 32B, and 32C. For example, if the first component 31 is an energy metering component, it may receive electricity charge information, and then, may transmit it to an energy management component and an energy consumption component.

Moreover, each of the first to fourth components may communicate with another component. For example, the first component 31 may be an energy metering component, and the second component 32A may be an energy management component. Also, the energy management component may communicate with at least one energy consumption component.

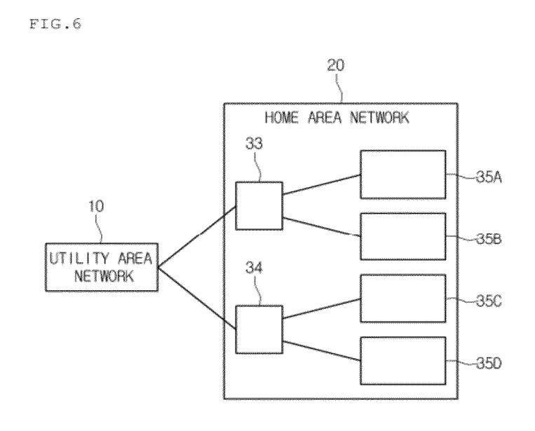

FIG. 6 is a schematic block diagram illustrating a second communication form of a network system according to the present invention.

Referring to FIG. 6, some of a plurality of components constituting the HAN 20 of the present invention may directly communicate with the UAN 10.

That is, the present invention includes a plurality of components (the first and second components 33 and 34) serving as a gateway. The first and second components may have the same type or different types.

Moreover, the first component 33 may communicate with at least one component (for example, the third and fourth components 35A and 35B), and the second component 34 may communicate with at least one component (for example, fifth and sixth components 35C and 35D).

For example, each of the first and second components may be one of an energy management component, an energy metering component, a central management component, an energy grid assistance component, and an energy consumption component, for example.

Each of the third to sixth components may be one of an energy generation component, an energy distribution component, an energy management component, an energy metering component, a central management component, an energy grid assistance component, and an energy consumption component, for example.

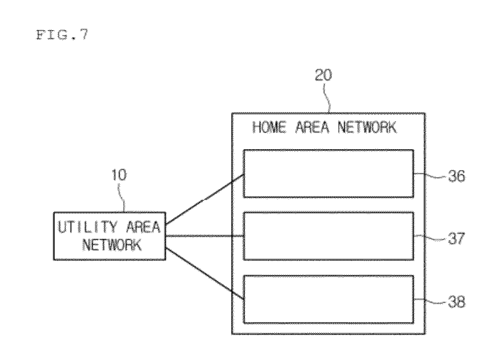

FIG. 7 is a schematic block diagram illustrating a third communication form of a network system according to the present invention.

Referring to FIG. 7, each of the components 36, 37, and constituting an HAN of this embodiment may directly communicate with the UAN 10. That is, like the first and second embodiments, each of the components 36, 37, and 38 may communicate with the UAN 10 without a component serving as a gateway.

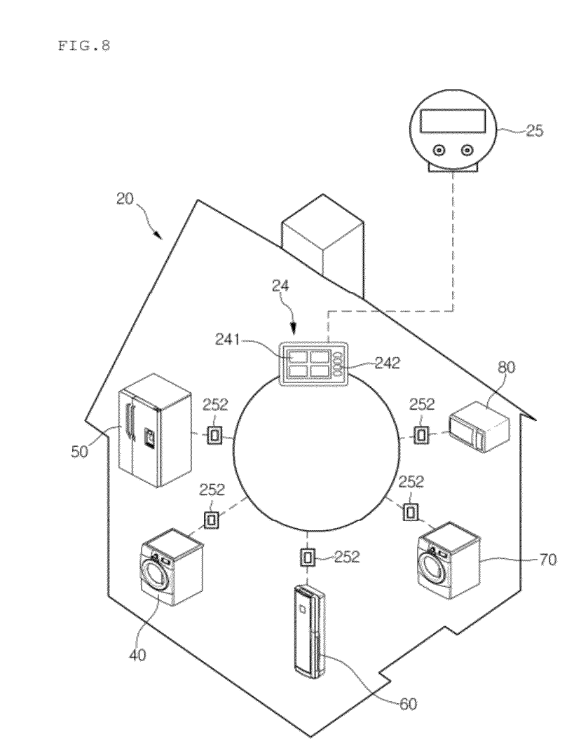

FIG. 8 is a schematic view illustrating an HAN of a network system according to the present invention.

Referring to FIG. 8, the HAN 20 may include an energy metering component 25 for metering power supplied from the UAN 10 to each home and/or electricity charge in real time, and an energy management component 24 for communicating with the energy metering component 25 and an appliance (an energy consumption component).

The appliance may include a washing machine 40, a refrigerator 50, an air conditioner 60, a driver 70, and a cooking device 80.

Each appliance may include a power meter 252 (i.e., a second energy metering component) for metering supplied power amount and/or consumed power amount in real time. That is, the power meter 252 may meter a power amount for each appliance, and the energy metering component 25 (i.e., a first energy metering component) may meter an entire energy consumption amount consumed in the HAN 20, that is, an entire electricity consumption amount.

The energy management unit 24 may include a display unit 241 for displaying information recognizable by a user, and an input unit 242 for inputting various commands or information by a user. The energy management component 24 and/or each appliance may receive power amount data from each power meter 252.

The display unit 241 may display at least one of a power amount supplied to each appliance, a power amount consumed by each appliance, an energy usage charge for each appliance, a predicted power amount used in each appliance, and a predicted energy usage charge for each appliance.

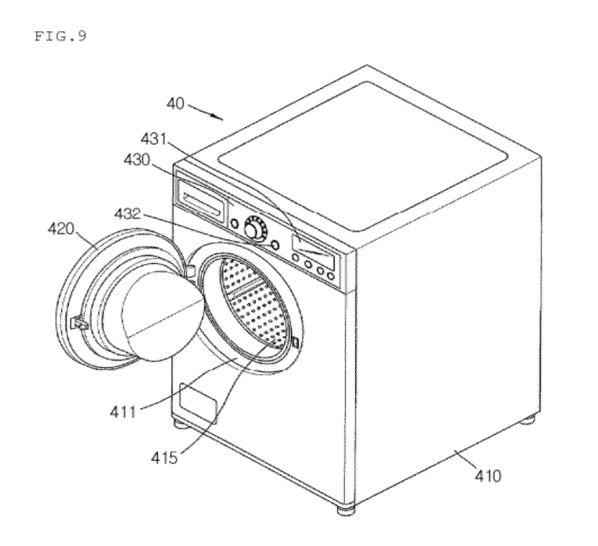

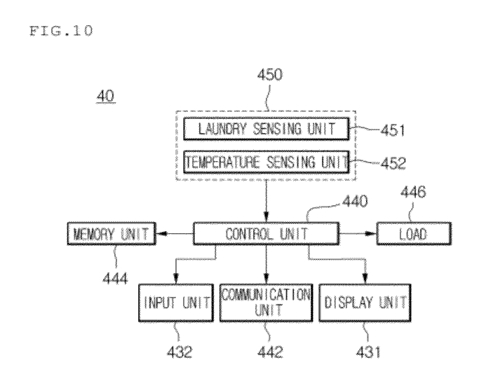

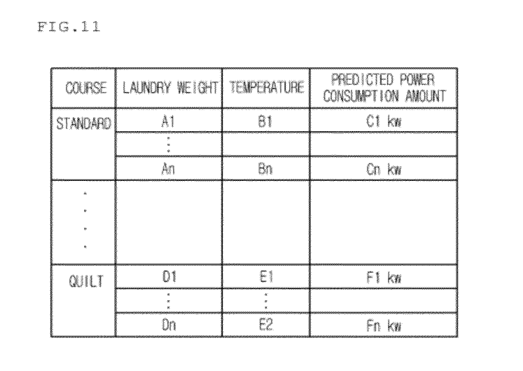

FIG. 9 is a perspective view illustrating a washing machine according to a first embodiment of an energy consumption component constituting an HAN of the present invention. FIG. 10 is a block diagram of the washing machine of FIG. 9. FIG. 11 is a view illustrating information stored in a memory unit of the washing machine.

The washing machine is shown in FIG. 9, and its description may be identically applied to that of a drier. Thus, detailed description for the drier will be omitted.

Referring to FIGS. 9 to 11, the washing machine 40 may include a cabinet 410 having a slot 411 for putting in or taking out the laundry, a drum 415 in the cabinet 410 for receiving the laundry, a door 420 connected to the cabinet 410 to open or close the slot 411, and a control panel 430 having a display unit 431 and an input unit 432.

Additionally, the washing machine 40 may include a sensing unit 450 for sensing at least the laundry amount and supplied water temperature, a control unit 440 for recognizing the information sensed by the sensing unit 450 and controlling a load 446, a communication unit 442 for communicating with another component, and a memory unit 444 for storing information thereof or information received from another component.

The load 446 may include at least one energy consumption component (for example, a heater, a motor, and a valve) constituting the washing machine.

In more detail, at least an operating course (or mode) of the washing machine may be selected through the input unit 432. Additionally, an operating condition on the selected course may be inputted through the input unit 432. The course may include at least one cycle, and an operating condition on the course means an operating condition in at least one cycle.

The course may include a standard course, a strong course, quilt, and boiling. An operating condition of the selected course may include the number of rinsing, washing temperature, spin-drying, drum RPM in a dry cycle, and the number of spin-drying.

The sensing unit 450 includes a laundry amount sensing unit 451 for sensing the amount of the laundry, and a temperature sensing unit 452 for sensing a supplied water temperature.

The memory unit 444 includes a table in which a predicted power consumption amount according to a selected course, the laundry amount, and a temperature is stored. That is, an accumulated predicted power consumption amount (hereinafter, referred to as “predicted power consumption amount) of when washing with respect to a specific laundry amount is finished at a specific supplied water temperature in a specific course is stored in the memory unit 444. The predicted power consumption amount may be determined through a plurality of tests. In this embodiment, the laundry amount and supplied water temperature are factors related to an operation of an element (i.e., a load). In another aspect, the laundry amount and supplied water temperature are factors determining on-time. The on-time of the element is a ratio (a relative value) of on-time in the sum of on-time and off-time, or may mean actual power on-time. The element may be a heater, a motor, a valve, or a display unit.

Additionally, a power amount stored in the memory unit 444 may be changed. Changing the stored power amount will be described later.

The display unit 431 may display at least a power consumption amount and an energy usage charge. Of course, the display unit 431 may display another energy information and/or additional information besides the power consumption amount and the energy usage charge.

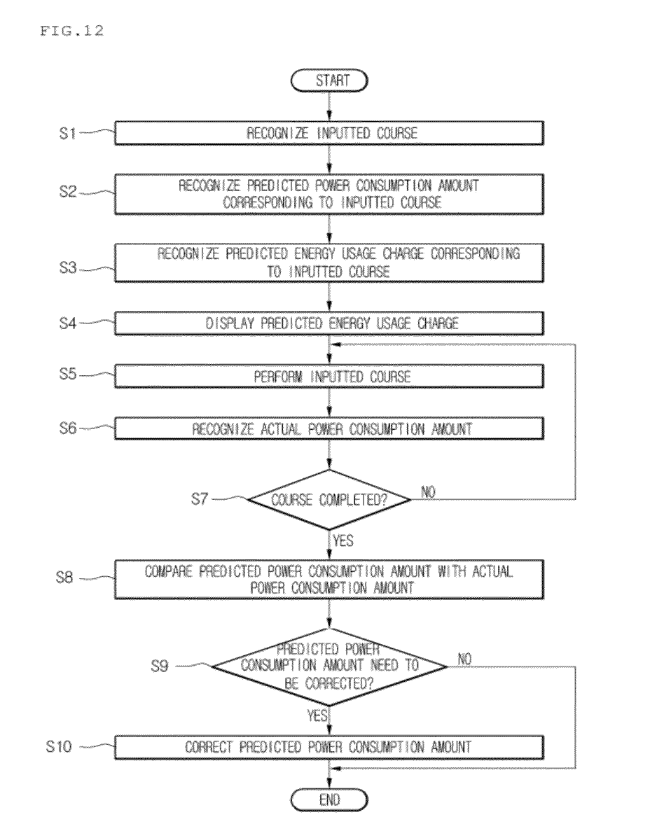

FIG. 12 is a flowchart illustrating a control method of a network system according to a first embodiment of the present invention.

Referring to FIG. 12, the control unit 440 of the washing machine 40 may recognize an inputted course in operation S1. The control unit 440 may recognize course information inputted from the input unit 432 or course information received from another component. As one example, another component may be a central management component, an energy management component, or an energy metering component.

After recognizing the inputted course, the control unit 440 recognizes a predicted power consumption amount corresponding to the inputted course in operation S2. In more detail, after recognizing the inputted course, the control unit 440 recognizes the laundry amount sensed from the laundry amount sensing unit 451 and the supplied water temperature sensed from the temperature sensing unit 452. Then, the control unit 440 may recognize a predicted power consumption amount corresponding to the inputted course and the sensed laundry amount and temperature in operation S3.

Although it is described in this embodiment that a predicted power consumption amount is stored in the memory unit 444 of the washing machine 40, the control unit 440 may receive predicted power consumption amount information stored in a memory unit of another component. In this embodiment, the fact that the control unit receives and recognizes predicted power consumption amount information may be described in correspondence to the fact that a washing machine (i.e., an energy consumption component) including a control unit recognizes the information.

Then, the control unit 440 recognizes a predicted energy usage charge corresponding to the inputted course in operation S3. In more detail, the control unit 440 may recognize a real time electricity charge or a scheduled electricity charge. Accordingly, the predicted energy usage charge may be obtained by multiplying the recognized predicted power consumption amount by the recognized electricity charge. Unlike that, the control unit 440 may recognize a predicted energy usage charge determined by another component.

When the control unit 440 recognizes a real time charge, a predicted energy usage charge may be determined based on an electricity charge at the recognition timing, or based on electricity charge information stored in a memory unit in advance.

Moreover, the display unit may display the predicted energy usage charge in operation S4. Moreover, the display unit may display the predicted power consumption amount.

Then, the washing machine 40 performs washing in an inputted course in operation S5. While the washing machine 40 performs washing, the control unit 440 may recognize an actual power amount that the washing machine consumes in operation S6. That is, the control unit 440 may directly recognize actual power consumption amount information metered by the power meter 252 or may recognize the information received from another component. Additionally, the actual power consumption amount may be stored in the memory unit 444. Moreover, the control unit 440 may recognize an actual energy usage charge. The actual energy usage charge may be obtained by multiplying the recognized actual power consumption amount by the recognized electricity charge.

Then, it is determined in operation S7 whether the course is completed while the washing machine performs washing. If the course is not completed, it returns to operation S5. On the contrary, if the course is completed, the control unit 440 compares the predicted power consumption amount with the actual power consumption amount in operation S8. Then, it is determined in operation S9 whether correction on the predicted power consumption is necessary. Based on a determination result, if correction on the predicted power consumption amount is necessary, a predicted power consumption amount stored in the memory unit is corrected in operation S10. If correction on the predicted power consumption amount is necessary, it means that a difference value between the predicted power consumption amount and the actual power consumption amount exceeds a predetermined reference.

If correction on the predicted power consumption amount is necessary, a predicted power consumption amount stored in the memory unit of the washing machine or a memory unit of another component changes into the actual power consumption amount.

While the washing machine operates, the display unit continuously may display a predicted power consumption amount and/or a predicted energy usage charge, and after a course of the washing machine is completed, the display unit may display an actual power consumption amount and an actual energy usage charge in addition to the predicted power consumption amount and/or the predicted energy usage charge.

As another example, while the washing machine operates, the display unit continuously may display a predicted power consumption amount and/or a predicted energy usage charge, and after a course of the washing machine is completed, the display unit may display only an actual power consumption amount and an actual energy usage charge.

As another example, when the washing machine operates, the display unit may display a predicted power consumption amount and/or a predicted energy usage charge in addition to an actual power consumption amount and/or an actual energy usage charge.

Moreover, the display unit may display the predicted greenhouse gas emission amount. The predicted greenhouse gas emission amount mean a predicted amount of greenhouse gas emitted, and may be determined by multiplying a predicted power consumption amount and a greenhouse gas index or multiplying an actual power consumption amount and a greenhouse gas index.

The washing machine was described as one example in the above embodiment, and may be identically applied to an appliance in which a course input is available, or a course input and a course condition input are available.

As one example, since a course input and a course condition input are available in a cooking device, a drier, and a dish washer, the contents descried with reference to FIG. 11 are applied to them as it is. At this point, a cooking temperature of the cooking device is a factor related to an operation of an element.

In this embodiment, information that the control unit 440 of the washing machine 40 recognizes (for example, actual/predicted power consumption amount, and actual/predicted energy usage charge) may be recognized by another component communicating with the washing machine. That is, another component may receive and recognize information that the control unit 440 recognizes, or the control unit may receive and recognize information that another component recognizes. As one example, a display unit of the another component may display a power consumption amount and/or an energy usage charge.

According to this embodiment, since components constituting a network system may transmit and/or receive at least energy information, effective management of an energy source is possible.

Additionally, since appliances (i.e., an energy consumption component) may display a predicted power consumption amount and/or a predicted energy usage charge, a user may easily confirm energy related information. Thus, the user may effectively use the appliances in order to save energy or energy charge.

Furthermore, if correction is required because there is a difference between a predictable power consumption amount stored in a memory unit and an actual power consumption amount, the predictable power consumption amount stored in the memory unit is changed into the actual power consumption amount. Therefore, a more accurate predictable power consumption amount may be displayed.

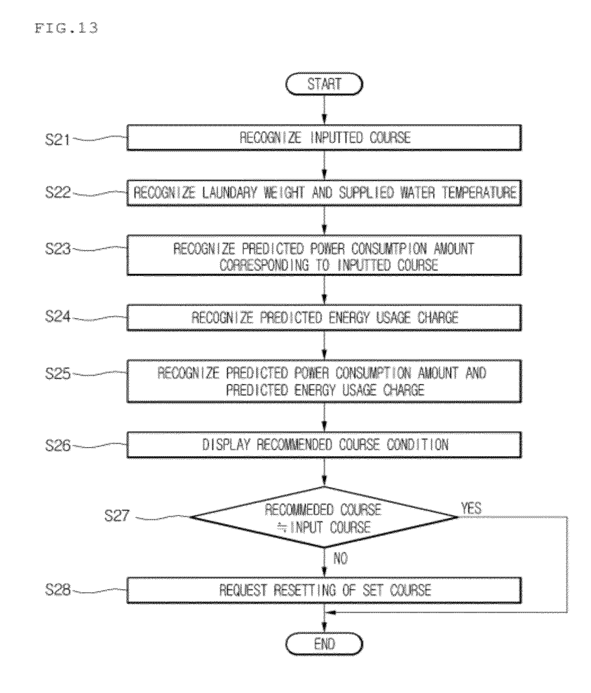

FIG. 13 is a flowchart illustrating a control method of a network system according to a second embodiment of the present invention.

Referring to FIG. 13, the control unit 440 of the washing machine 40 may recognize an inputted course in operation S21. The control unit 440 may recognize course information inputted from the input unit 432 or course information received from another component. As one example, another component may be a central management component, an energy management component, or an energy metering component.

Additionally, the control unit 440 may recognize the laundry amount and supplied water temperature in operation S22. Then, the control unit 440 may recognize a predicted power consumption amount corresponding to the inputted course and the sensed laundry amount and temperature in operation S23. Then, the control unit 440 recognizes a predicted energy usage charge corresponding to the inputted course in operation S24. Moreover, the display unit 431 may display the predicted energy usage charge in operation S25. Moreover, the display unit 431 may display the predicted power consumption amount.

Then, a course recommendation condition may be displayed based on the inputted course condition and the sensed laundry amount and temperature in operation S26. The recommendation condition may be the rotational speed of a drum in a spin-drying or a dry cycle of the washing machine, for example. The rotational speed of the drum may be one in a standard course, for example.

Then, it is determined in operation S27 whether an error between the inputted course condition and the recommended course exceeds a predetermined range. If the error exceeds the predetermined range, the display unit may display information on notification for requesting the resetting of the inputted course condition. If a user does not reset the course condition, the washing machine operates under the initially set course condition, and if the user reset the course condition, the washing machine operates under the reset course condition.

Once the washing machine operates, its control may identical to that of the first embodiment.

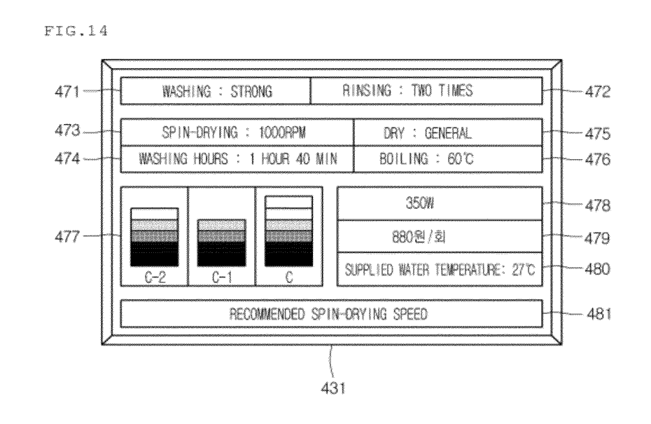

FIG. 14 is a view illustrating information displayed on a display unit according to a second embodiment of the present invention.

Referring to FIG. 14, the display unit 431 displays a setting status of when a user sets a washing machine, and a washing machine cycle progression situation of when a washing machine cycle progresses. In more detail, cycles 471 to 476 set by a user, a predicted power consumption amount 478 and a predicted energy usage charge 479 of the washing machine according to a set cycle, a recommend spin-drying speed 481, a supplied water temperature 480, and the relative degree 477 of a power consumed for washing in a previous operation and a current power consumption are displayed.

Additionally, the display unit 431 may display an actual power consumption amount and an actual energy usage charge based on the recognized actual power consumption amount. Additionally, the display unit 351 may display statistics such as a trend of power consumption amount, a trend of energy usage charge, and their accumulations if necessary.

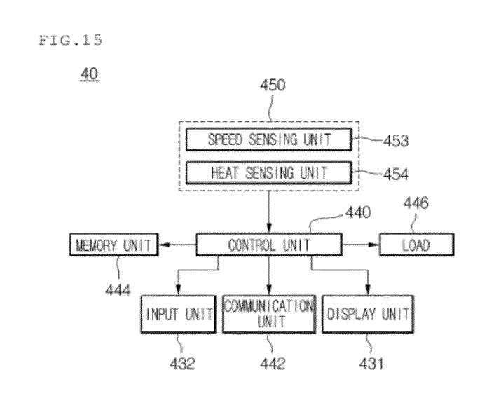

FIG. 15 is a block diagram of a washing machine according to a third embodiment of the present invention.

Referring to FIG. 15, the washing machine 40 may include a sensing unit 450 for sensing the laundry amount, an operation status of changing load, a changing amount of load, a control unit 440 for recognizing information sensed from the sensing unit 450 and controlling a load 446, a communication unit 442 for communicating with another component, and a memory unit 444 for storing information of the washing machine or information received from another component. Additionally, the washing machine 440 may further include a display unit 431 and an input unit 432.

Since this embodiment has the same configuration as the first embodiment and also the contents described in the first embodiment are applied to this embodiment as it is, the detailed description of this embodiment may be omitted.

The sensing unit 450 may include a speed sensing unit 453 for sensing a speed changing of a motor, and a heat sensing unit 454 for sensing a heat generated from a heat generation means (for example, a heater) of the washing machine 40.

If the motor of the washing machine does not have a rated output but is a variable speed motor, a power consumed according to speed is changed. Therefore, the speed sensing unit 421 senses the speed of a motor. When water is heated to increase a supplied water temperature, a power consumption amount of a heater, which is consumed for heating water up to a final target temperature, is changed according to the temperature of supplied water. Therefore, the heat sensing unit 422 senses a heat. That is, the sensing unit 450 may sense a variable output of the load.

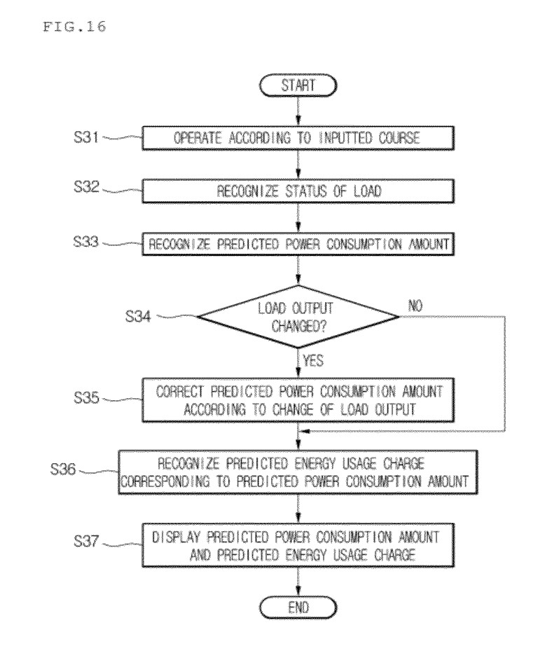

FIG. 16 is a flowchart illustrating a control method of a network system according to a third embodiment of the present invention.

Referring to FIGS. 15 and 16, the control unit 440 of the washing machine 40 operates according to an inputted course in operation S31. The control unit 440 may recognize a status of the load while the washing machine 40 operates. Additionally, the control unit 440 may recognize the laundry amount and supplied water temperature.

Then, the control unit 440 may recognize a predicted power consumption amount corresponding to the inputted course and the sensed laundry amount and temperature in operation S33.

Then, the control unit 440 determines whether an output of the load is changed in operation S34. If an output of a specific load is changed, a predicted power consumption amount may be changed (corrected) according to an output changing amount in operation S35.

Moreover, the control unit 440 may recognize a predicted energy usage charge corresponding to the changed predicted power consumption amount in operation S36. Moreover, the display unit may display a predicted energy usage charge and/or a predicted power consumption amount in operation S37. At this point, the charge and/or power amount information may be displayed after the course is completed.

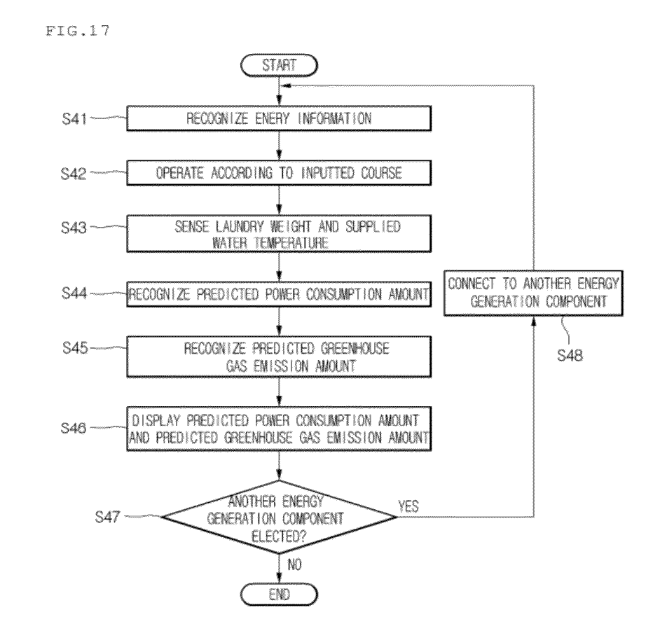

FIG. 17 is a flowchart illustrating a control method of a network system according to a fourth embodiment of the present invention.

Referring to FIG. 17, the control unit 440 of the washing machine 40 may recognize energy information in operation S41. In this embodiment, the energy information includes at least a type of an energy generation component and energy charge information.

Moreover, when an input of a specific course is recognized, the washing machine 40 operates according to an inputted course in operation S42. Additionally, the control unit 440 may recognize the laundry weight and supplied water temperature in operation S43.

Then, the control unit 440 may recognize a predicted power consumption amount corresponding to the inputted course and the sensed laundry weight and temperature in operation S44. Moreover, the control unit 440 may recognize a predicted energy usage charge corresponding to a predicted power consumption amount. Additionally, the control unit 440 recognizes predicted greenhouse gas emission amount of a specific energy generation component on the basis of the predicted power consumption amount in operation S45. The predicted greenhouse gas emission amount may be calculated by multiplying the predicted power consumption amount and a greenhouse gas index. The greenhouse gas index may be received from another component or may be stored in the memory unit of the washing machine.

Moreover, the predicted power consumption amount and predicted greenhouse gas emission amount may be displayed on the display unit in operation S46. Moreover, the display unit may display the predicted energy usage charge. In this embodiment, the power consumption amount information and predicted greenhouse gas emission amount information are displayed while the washing machine operates.

Then, the control unit 440 determines whether another energy generation component is selected in operation S47. That is, a user may select a type of an energy generation component by confirming the predicted greenhouse gas emission amount information displayed on the display unit. Then, the control unit determines whether another energy component besides an energy generation component, which supplies energy to the washing machine currently, is selected. If another energy generation component is selected, the washing machine receives energy from an energy generation component, which is selected because it is connected to the selected energy generation component, in operation S48.

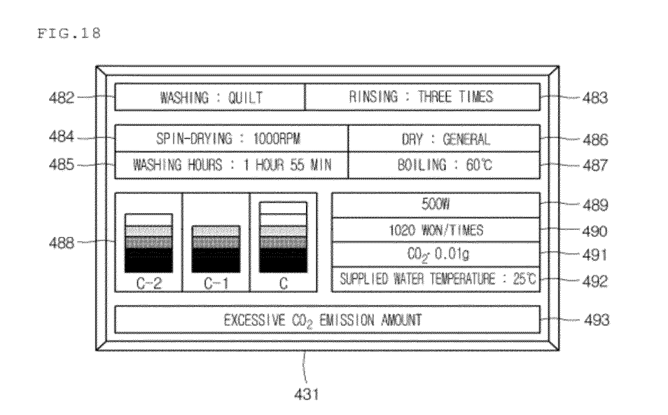

FIG. 18 is a view illustrating a display unit of a washing machine according to a fourth embodiment of the present invention.

Referring to FIG. 18, the display unit 431 displays a setting status of when a user sets a washing machine, and a washing machine cycle progression situation of when a washing machine cycle progresses. In more detail, cycles 482 to 487 set by a user, a predicted power consumption amount 489 and a predicted energy usage charge 490 of the washing machine according to a set cycle, a predicted carbon dioxide emission amount 492, information on power saving 493, a supplied water temperature 492, and the relative degree 488 of a power consumed for washing in a previous operation and a current power consumption are displayed.

Additionally, the display unit 431 may display an actual power consumption amount and an actual energy usage charge based on the recognized actual power consumption amount. Additionally, the display unit 351 may display statistics such as a trend of power consumption amount, a trend of energy usage charge, and their accumulations if necessary.

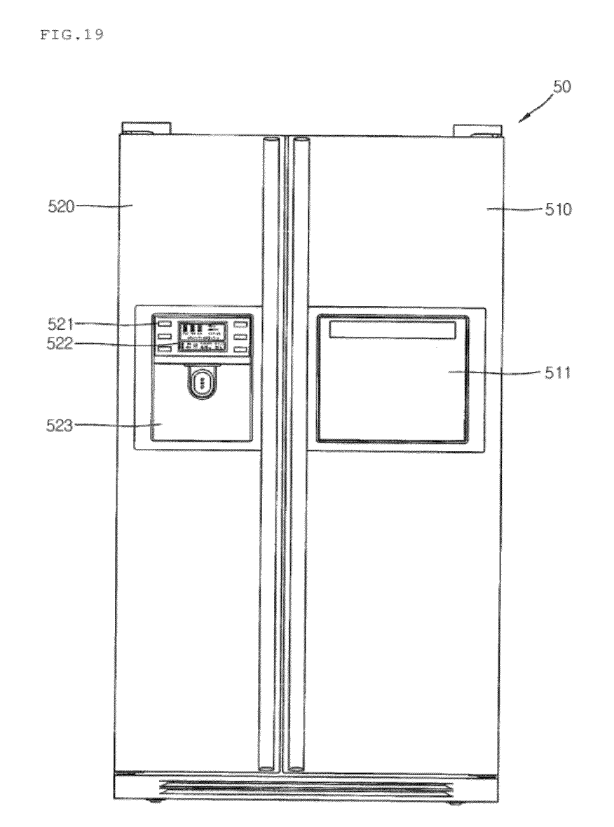

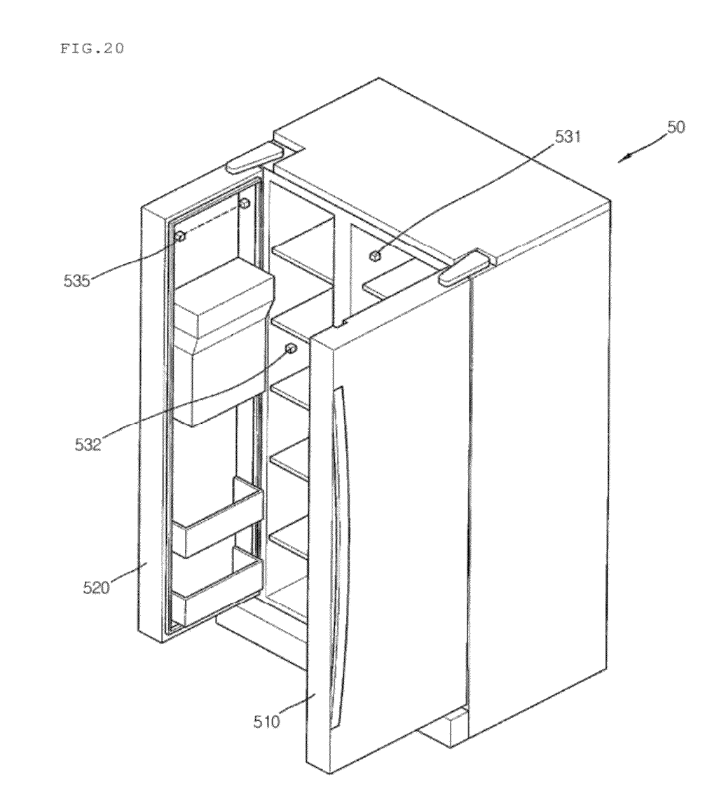

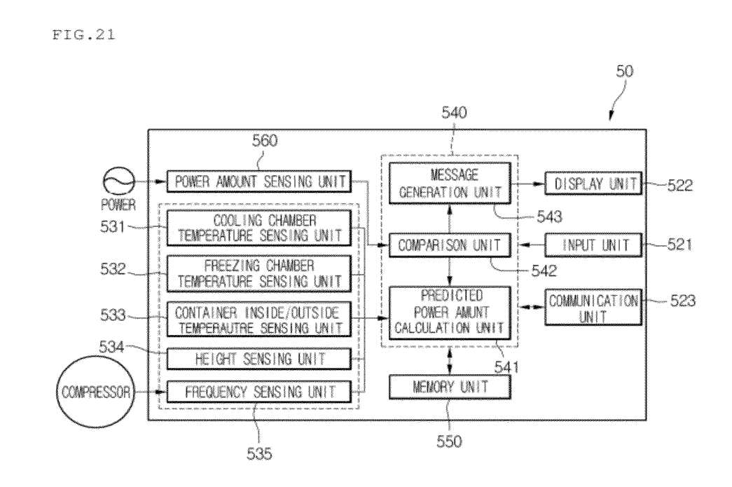

FIG. 19 is a front view of a refrigerator constituting an HAN according to a fifth embodiment of the present invention. FIG. 20 is a perspective view of the refrigerator of FIG. 19. FIG. 21 is a block diagram illustrating a configuration of the refrigerator of FIG. 19.

Referring to FIGS. 19 to 21, the refrigerator 50 includes a main body including a cooling chamber and a freezing chamber therein, a cooling chamber door 510 for opening/closing the cooling chamber, and a freezing chamber door 520 for operating/closing the freezing chamber.

The cooling chamber door 510 may include a home bar 511 for easily taking out or putting in goods. The freezing chamber door 520 may include a dispenser 523 for dispensing water and/or ice.

Additionally, the refrigerator 50 may include a status sensing unit 530 for sensing a plurality of container inside/outside statuses of the refrigerator 50, a calculation unit 541 for calculating a predicted power consumption per unit time (Kw/h: hereafter, referred to as “predicted power consumption”) or a predicted power consumption amount for a predetermined time (Kw: hereinafter, referred to as “predicted power consumption amount”) on the basis of the statuses, a control unit 540 for generating at least one message corresponding to the container inside/outside status, a display play unit for displaying at least the message, and a power amount sensing unit 560 connected to an input power source to sense a power amount supplied to the refrigerator 50.

In this embodiment, the predicted power consumption (kW/h) or the predicted power consumption amount (kW) may be named as predicted power information.

The power amount sensing unit 560 senses a supply power amount supplied to the refrigerator 50. The power amount sensing unit 560 may sense power amount through various methods. For example, the power amount sensing unit 560 may sense current and voltage, which are applied to the refrigerator 50, through a current sensing unit (not shown) and a voltage sensing unit (not shown), and then, may sense power amount by reflecting a time measured using a timer. The power amount sensing unit 560 is separately connected to the refrigerator 50 and sense a power consumption amount of the refrigerator 50 itself. The control unit 540 may calculate a greenhouse gas emission amount and an actual energy usage charge of an energy generation component on the basis of the sensed supply power amount, and may provide information on power saving according thereto to a user. Additionally, the control unit 540 may provide statistics to a user through the display unit 522. The statistics may include trends and accumulations of the supply power amount, greenhouse gas emission amount, predicted power information, and actual energy usage charge (such as an energy usage charge per unit time or an accumulative usage charge for a specific period).

The status sensing unit 530 senses the container inside/outside status of the refrigerator 50. The status sensing unit 530 may include some or all of a cooling chamber temperature sensing unit 531, a freezing chamber temperature sensing unit 532, a container outside temperature sensing unit 533, a height sensing unit 534, and a frequency sensing unit 535.

The container outside temperature sensing unit 533 senses a room temperature. The height sensing unit 534 may sense the height of goods stored in the refrigerator. The height sensing unit 534 may be installed at each of the cooling chamber and the freezing chamber. Or, if there are a plurality of cooling chambers and freezing chambers, a plurality of height sensing units may be respectively installed at them.

The height sensing unit 534 may include one pair of an infrared sensor and an ultrasonic sensor, each having a transmitter and a receiver. Through this, it is determined whether the receiver receives a signal transmitted from the transmitter, so that the height of stored goods may be easily sensed.

Additionally, the calculation unit 541 may calculate the predicted power or predicted power amount according to each status value of the status sensing unit 530. When only a status value sensed by one status sensing unit is changed and status values sensed by the other remaining status sensing units are not changed among the status sensing units 530, the calculation unit 541 calculates a predicted power consumption or a predicted power consumption amount by observing changes of power or power amount corresponding to the changing status value. For example, if a temperature of a cooling chamber is changed while the other status values are maintained as it is in the status sensing unit 530, a predicted power consumption or a predicted power consumption amount may be calculated on the basis of the temperature of the refrigerator. At this point, statuses other than the refrigerator temperature are already reflected during power consumption/power amount calculation.

The frequency sensing unit 535 may sense a driving frequency of a compressor for driving the refrigerator. In general, cool air is supplied into the refrigerator by driving the compressor in controlling the refrigerator. That is, the cool air is generated through heat exchange effects of a refrigerant, and is continuously supplied into the refrigerator through repeated cycles of compression-condensation-expansion-evaporation. This supplied refrigerant is uniformly delivered into the refrigerator through convection, so that foods in the refrigerator may be stored at a desired temperature.

The calculation unit 541 may calculate a predicted power consumption/power amount on the basis of a driving frequency sensed through the sensing unit 535. That is, a supply power amount is sensed on the biases of a power amount supplied to the refrigerator 50 through the power amount sensing unit 560, and a predicted power consumption/power amount is calculated on the basis of a driving frequency sensed through the frequency sensing unit 535.

Moreover, although not shown in the drawings, a change of voltage or current applied to a compressor for driving the refrigerator is sensed, and based on this, a predicted power/power amount consumed in the refrigerator may be calculated.

The control unit 540 may calculate an energy usage charge on the basis of the supply power amount sensed through the power amount sensing unit 560. The control unit 540 continuously receives a supply power amount for a predetermined period or until a current time, which is sensed through the power amount sensing unit 560, and then, calculates an energy usage charge by using the recognized electricity charge.

Additionally, the control unit 540 calculates a predicted greenhouse gas emission amount of an energy generation component that supplies energy to the refrigerator on the basis of the predicted power consumption amount or the supply power amount. For example, the predicted greenhouse gas emission amount may be calculated by multiplying a greenhouse gas index and the predicted power consumption amount or the supply power amount.

Additionally, the control unit 540 generates at least one message corresponding to the container inside/outside statuses of the refrigerator, which are sensed through the state sensing unit 530. After the container inside/outside statuses such as a temperature in the cooling chamber, a temperature in the freezing chamber, a container outside temperature, a height of stored goods, an amount of stored goods according to a height of stored goods, a driving frequency of the compressor, the number of opening/closing a door, and opening time are analyzed, and then, the control unit 540 generates a message corresponding to the analysis. For example, if a temperature is too low in the cooling chamber and becomes a subzero temperature, stored goods are frozen. Thus, a message for “temperature in cooling chamber is below zero” is generated to increase the temperature in the cooling chamber. Additionally, if an amount of stored goods in the freezing chamber is too much and thus more power is consumed, a message for “reduce amount of stored goods in freezing chamber” is generated. Moreover, if there is too much greenhouse gas, i.e., predicted carbon dioxide emission amount, of an energy generation component supplying energy to a current refrigerator, a message for “too much carbon dioxide emission amount” or “replace with another energy generation component” is generated.

Kinds of the container inside/outside statuses and reference status values according thereto may be set in advance, and then, stored in the memory unit 550. That is, some or all of the container inside/outside status are used if necessary. Additionally, the control unit 540 sets a reference status for each of the container inside/outside statuses in advance, compares current values of the container inside/outside statuses with predetermined reference status values, and generates a message according to a comparison result. That is, the control unit 540 may further include a comparison unit 542 for comparing the container inside/outside statuses with predetermined reference status and a message generation unit 543 for generating at least one message corresponding to the container inside/outside statuses on the basis of the comparison result.

A greenhouse gas index according to types of an energy generation component may be further stored in the memory unit 550.

Moreover, the refrigerator 50 according to the present invention may further include a sensor (not shown) for sensing opening/closing a door, and the control unit 540 may determine a trend of actual power consumption amount by using the number of opening/closing a door or door opening hours, which is sensed through the sensor, and then, may calculate an actual energy usage charge according thereto. Additionally, a power saving tip for “reduce the number of opening/closing a door” may be generated based on the actual power consumption amount and actual energy usage charge.

A message generated through the control unit 540 may include types of the container inside/outside statuses, current values of the container inside/outside statuses, trends of the container inside/outside statuses, control setting values, and power saving tips.

Values sensed through the power amount sensing unit 560 or the status sensing unit 530 may become messages as it is, and then, may be displayed on the display unit. Or, trends calculated based on the sensed container inside/outside status values may become messages, and the, may be displayed on the display unit. Additionally, control setting values necessary for operating the refrigerator may be converted into messages and then displayed. Or, power saving tips according to the container inside/outside statuses may be generated as messages.

The control unit 522 may display one of the sensed supply power amount, the predicted power consumption amount, and the energy usage charge.

Additionally, the refrigerator of this embodiment may further include an input unit for inputting a command to display the power amount and the message on the display unit 522, and a communication unit 523 for communicating with another component.

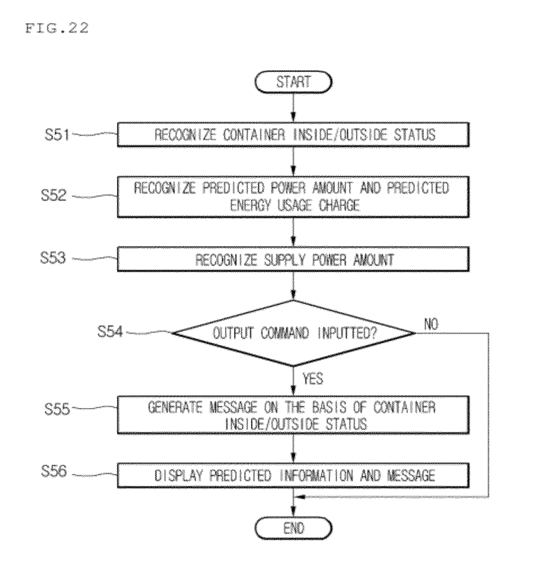

FIG. 22 is a flowchart illustrating a control method of a network system according to a fifth embodiment of the present invention.

Referring to FIG. 22, the control unit 540 may recognize a container inside/outside status in operation S51. Also, the control unit 540 may calculate a predicted power consumption/power amount on the basis of the recognized status. Additionally, the control unit 540 may recognize the supplied power amount in operation S53. The control unit 540 may recognize an actual energy usage charge on the basis of the recognized supplied power amount.

Then, the control unit 540 determines whether a message output command is inputted through the input unit in operation S54. If the message output command is inputted, the control unit 540 may generate at least one message corresponding to the container inside/outside statuses in operation S55. Then, the message generated from the display unit and predicted power information or actual energy usage information are displayed in operation S56. Moreover, the display unit may display the predicted greenhouse gas emission amount.

At this point, a user may select a type of an energy generating component that supplies energy to the refrigerator. If a user changes a type of an energy generation component, the changed energy generation component may supply energy to the refrigerator.

In the case of the refrigerator, since it operates continuously, the container inside/outside status may change continuously. Therefore, by displaying a predicted power/power amount, a user may easily predict an energy usage status.

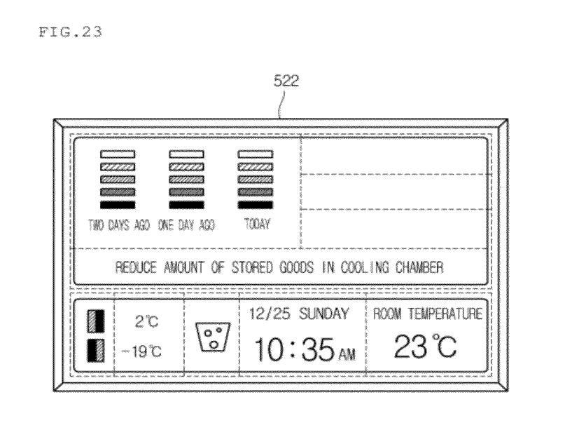

FIG. 23 is a view illustrating information displayed on a display unit of a refrigerator according to a fifth embodiment of the present invention.

Referring to FIG. 23, the display unit 522 displays status values and messages (such as a predicted power amount, an actual energy usage charge, a trend of power consumption amount, an amount of food, and a power saving tip (for example, “reduce amount of stored goods in cooling chamber”).

The predicted power consumption amount may be power amount in a daily, weekly, monthly, yearly, or predetermined period according to button manipulation, and also its trend may vary periodically.

Additionally, the display unit may display the positions of a cooling chamber and a freezing chamber, an inside/outside temperature of each chamber, an ice status, a current time, a room temperature outside a chamber, a predicted carbon dioxide emission amount, and a large or small amount of carbon dioxide emission amount.

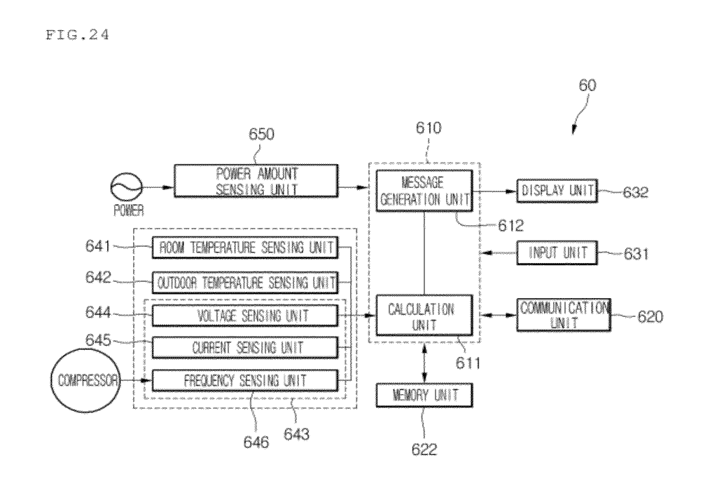

FIG. 24 is a block diagram of an air conditioner constituting an HAN according to a sixth embodiment of the present invention.

Referring to FIG. 24, the air conditioner 60 may include an input unit 631 for inputting at least one setting command necessary for operations of the air conditioner 60, a status sensing unit 640 for sensing a plurality of statuses that vary according to the setting command, a control unit 610 for calculating predicted power information on the basis of the statuses and generating at least one message corresponding to the statuses, and a display unit 632 for displaying the predicted power information and/or the message.

The predicted power information includes a predicted power consumption per unit time (Kw/h: hereinafter, referred to as “predicted power consumption”) and/or a predicted power consumption amount for predetermined time (Kw: hereinafter, referred to as “predicted power consumption amount”).

The input unit 631 sets an operation mode for operating the air conditioner. The input unit 631 includes a selection unit having a plurality of buttons. Here, the selection unit may input at least one setting command of an operation mode, a target temperature, an air amount, an air direction, and a timer.

The status sensing unit 640 includes a room temperature sensing unit 641 for sensing a temperature at the installed position of the air conditioner, an outdoor temperature sensing unit 642 for sensing an outdoor temperature, and a compressor status sensing unit 643 for sensing a status of a compressor that driving the air conditioner.

The compression status sensing unit 643 may include a voltage sensing unit 644 for sensing a voltage applied to the compressor, a current sensing unit 645 for sensing a current supplied to the compressor, and a frequency sensing unit 646 for sensing a driving frequency that derives the compressor. Additionally, the compression status sensing unit 643 may further include sensors for sensing a driving speed of a fan motor or whether the fan motor is driven.

The control unit 610 includes a calculation unit 611 for calculating a predicted power/power amount on the basis of statuses values sensed through the status sensing unit 640 and calculating an actual usage charge, and a message generation unit 612 for generating a message. Moreover, the control unit 610 may calculate an actual energy usage charge on the basis of a supply power amount sensed from the power amount sensing unit 650.

Additionally, the control unit 610 may receive information from another component through the communication unit 620.

Since the air conditioner of this embodiment calculates a predicted power, a predicted power amount, and an actual energy usage charge through the same method as the refrigerator of the above fifth embodiment, its detailed description will be omitted.

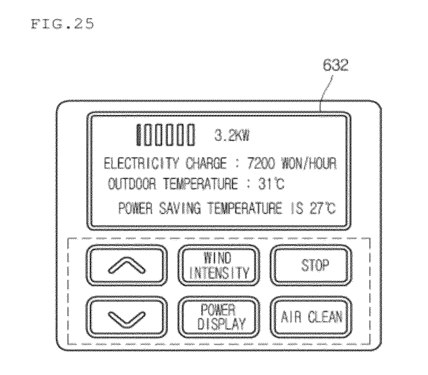

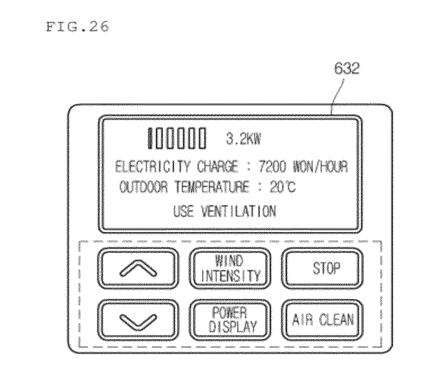

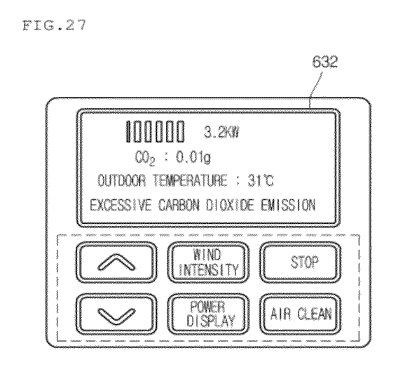

FIG. 25 is a view illustrating information displayed on a display unit of an air conditioner according to a sixth embodiment of the present invention. FIG. 26 is a view illustrating information displayed on an air conditioner according to a seventh embodiment. FIG. 27 is a view illustrating information displayed on a display unit of an air conditioner according to an eighth embodiment of the present invention.

Referring to FIGS. 25 to 27, the display unit 632 may display a predicted power amount (or a predicted power), an actual energy usage charge, or a greenhouse gas emission amount of an energy generation component. Moreover, the display unit 632 may display a current room temperature and outdoor temperature. Additionally, the display unit 632 outputs a power saving tip with a message for “power saving temperature is 27° C.” or “operate in ventilation” after comparing a room temperature with a set temperature. Moreover, if an energy generation component receiving power currently has a large predicted carbon dioxide emission amount, the display unit 632 may display a message for “too much carbon dioxide emission amount” or a message for “replace with another energy generation component”.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A network system comprising:
a plurality of components for transmitting or receiving information,
wherein
at least one component among the plurality of components recognizes at least energy-related information and performs an energy-related response; and
when a first component in the plurality of components recognizes a course related to an operation of a second component, the first component recognizes a predicted energy usage charge on the basis of a predicted power consumption amount of the second component corresponding to the inputted course.

2. The network system according to claim 1, further comprising: a memory unit for storing the predicted power consumption amount corresponding to the inputted course.

3. The network system according to claim 2, wherein the memory unit and the first component are equipped in the second component.

4. The network system according to claim 3, wherein the second component is an energy consumption component; and
the first component is a control unit.

5. The network system according to claim 2, wherein the memory unit is equipped in the first component; and
the first component transmits the recognized predicted energy usage charge to the second component.

6. The network system according to claim 5, wherein the first component is one of an energy management component for managing energy, an energy metering component for metering energy, and a central management component for controlling at least one energy consumption component; and
the second component is an energy consumption component.

7. The network system according to claim 1, wherein the predicted power consumption amount is a power consumption amount determined based on a factor related to an inputted course and an operation of an element in the second component.

8. The network system according to claim 7, wherein the factor related to an operation of the element is one of a temperature and a consumable amount, which are related to an operation of the second component.

9. The network system according to claim 7, wherein the factor related to an operation of the element determines an on-time of the element.

10. The network system according to claim 9, the on-time of the element is a ratio (a relative value) of the on-time in the sum of the on-time and an off-time, or an actual power on-time (an absolute value).

11. The network system according to claim 1, further comprising a display unit for displaying at least one of the predicted power consumption amount and the predicted energy usage charge.

12. The network system according to claim 11, further comprising an energy metering component for metering an actual power consumption amount of the second component when the energy consumption component operates.

13. The network system according to claim 11, wherein an actual power consumption amount of the second component is recognized when the second component operates according to an inputted course; and
a predicted power consumption amount is corrected to an actual power consumption amount when the predicted power consumption amount is required to be corrected.

14. The network system according to claim 13, wherein the display unit displays a predicted greenhouse gas emission amount determined based on the predicted power consumption amount or the actual power consumption amount.

15. The network system according to claim 13, wherein, while the second component operates or after an operation of the second component is completed, the display unit displays at least one of the actual power consumption amount and an actual energy usage charge determined based on the actual power consumption amount.

16. The network system according to claim 11, wherein the display unit is equipped in at least one of the first component and the second component.
